(19) United States
(12) Patent Application Publication
(10) Pub. No.: US 2008/0286398 A1
(43) Pub. Date: Nov. 20, 2008

(54) Fast-to-install structure for a threaded rod of an injection molding machine

(76) Inventors: Jui-Hsiang Wang, Yung Kang City (TW); Chih-Hsiang Han, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/798,510

(22) Filed: May 15, 2007

(51) Int. Cl. B28B 1/24

(52) U.S. Cl. 425/179

(57) ABSTRACT

An injection molding machine includes a threaded rod, a shaft coupling, and a stopping slab; the shaft coupling is connected at a first end to an oil hydraulic motor; the threaded rod is inserted in an axial hole in the second end of the shaft coupling; the shaft coupling has a hollow detainment portion adjacent to the axial hole; the stopping slab is secured on the second end of the shaft coupling, and has a receiving hole, and a groove adjacent to the receiving hole; the groove is faced with only a portion of the hollow detainment portion, and in turn an opening of the hollow detainment portion is partly covered and blocked by the stopping slab; the threaded rod has a wedging protrusion thereon, which is loosely confined in the detainment portion; therefore, the wedging protrusion can be relocated between blocked and unblocked sections of the hollow detainment portion.

### BACKGROUND OF THE INVENTION

1. Field of the invention

The present invention relates to a fast-to-install structure for a threaded rod of an injection molding machine, more particularly one, which includes a shaft coupling and a simple stopping slab member for allowing a threaded rod to be easily and fast coupled to/separated from a working shaft of an oil hydraulic motor.

2. Brief Description of the Prior Art

A wide variety of plastic products used in our daily life are made by means of injection molding with injection molding machines. A common injection molding machine structure includes a composite mold, a pulling and pushing mechanism, and a material injecting unit.

The composite mold comprises a female mold part, which has a cavity, and a male mold part to mate with the female part.

The pulling and pushing mechanism is connected to a back of the male mold part for moving the male mold part so as to open/close the mold.

The material injecting unit includes a sliding seat, oil hydraulic cylinders fitted to two sides of the sliding seat, an oil hydraulic motor disposed on the sliding seat, a material sending conduit arranged in front of the sliding seat, a heat device fitted on the material sending conduit, a funnel joined to the conduit, and a threaded rod, which is received in the conduit, and coupled to a central shaft of the oil hydraulic motor at a tail end so as to be rotated by means of the motor.

After the mold is closed, the oil hydraulic cylinders are actuated so as to cause linear displacement of the threaded rod relative to the material sending conduit; thus, melted plastic materials are injected from the material sending conduit into the mold.

Furthermore, a shaft coupling and two semicircular fixing members are provided, which couple the threaded rod to the central shaft of the oil hydraulic motor in order for allowing the threaded rod to be removed for replacement, repair and maintenance. The threaded rod has several keyways on a connecting tail end thereof while the shaft coupling has a receiving hole, and several keyways adjacent to the receiving hole on an inner side thereof. The semicircular fixing members each have a semicircular cavity, semicircular grooves, and semicircular protrusions communicating with the semicircular grooves, and they are securely joined together around a joint between the connecting tail end of the threaded rod and the shaft coupling, and keys are tightly held in the keyways; thus, the threaded rod, the semicircular fixing members, and the shaft coupling are secured together, and the threaded rod is allowed to separate from the central shaft of the oil hydraulic motor. The semicircular fixing members have wing portions sticking from them, and are secured together by means of passing bolts through the wing portions thereof.

It can be easily seen that the above structure is relatively complicated, and takes much cost to construct, and the keys are prone to get lost after they are removed. Furthermore, it will take relatively much labor and time to separate the above threaded rod from the semicircular fixing members and the shaft coupling after the shaft coupling is separated from the central shaft of the oil hydraulic motor; to separate the above parts, first the bolts of the semicircular fixing members have to be loosened, and the fixing members separated from the threaded rod and the shaft coupling, and next the keys have to be taken out of the keyways in order for allowing the threaded rod, the semicircular fixing members, and the shaft coupling to separate. And, it will also take much labor and time to assemble the above structure. Therefore, there is room for improvement.

### SUMMARY OF THE INVENTION

It is a main object of the present invention to provide a relatively simple fast-to-install structure for a threaded rod of an injection molding machine to overcome the above problems.

A fast-to-install structure according to an embodiment of the present invention includes a shaft coupling, and a stopping slab member; the shaft coupling is connected at a first end to an oil hydraulic motor, and a threaded rod is inserted in an axial hole of the second end of the shaft coupling; the shaft coupling has a hollow detainment portion adjacent to the axial hole. The shaft coupling further has a hollow detainment portion adjacent to the axial hole. The stopping slab member is secured on the second end of the shaft coupling, and has a receiving hole, and a groove adjacent to the receiving hole. The groove is faced with only a portion of the hollow detainment portion, and in turn an opening of the hollow detainment portion is partly covered and blocked by the stopping slab member. The threaded rod has a wedging protrusion thereon, which is confined in the hollow detainment portion of the shaft coupling. Therefore, the threaded rod will be stopped and prevented from moving in an axial direction relative to the shaft coupling after the shaft coupling has been rotated in one direction for the wedging protrusion to be located in the blocked section of the hollow detainment portion. And, the threaded rod is free to move in an axial direction relative to the shaft coupling, with its wedging protrusion facing the groove, after the shaft coupling is rotated in the reverse direction.

### BRIEF DESCRIPTION OF THE DRAWINGS

The present invention will be better understood by referring to the accompanying drawings, wherein:

FIG. 1 is a view of a fast installing structure of a threaded rod of an injection molding machine according to the present invention,

FIG. 2 is a front sectional view of the present invention,

FIG. 3 is a lateral sectional view of the present invention,

FIG. 4 is a view showing a step of installing the invention (1),

FIG. 5 is a view showing a step of installing the invention (2),

FIG. 6 is a view showing a step of installing the invention (3),

FIG. 7 is a front sectional view of a second preferred embodiment, and

FIG. 8 is a lateral sectional view of the second embodiment.

### DETAILED DESCRIPTION OF THE PREFERRED EMBODIMENTS

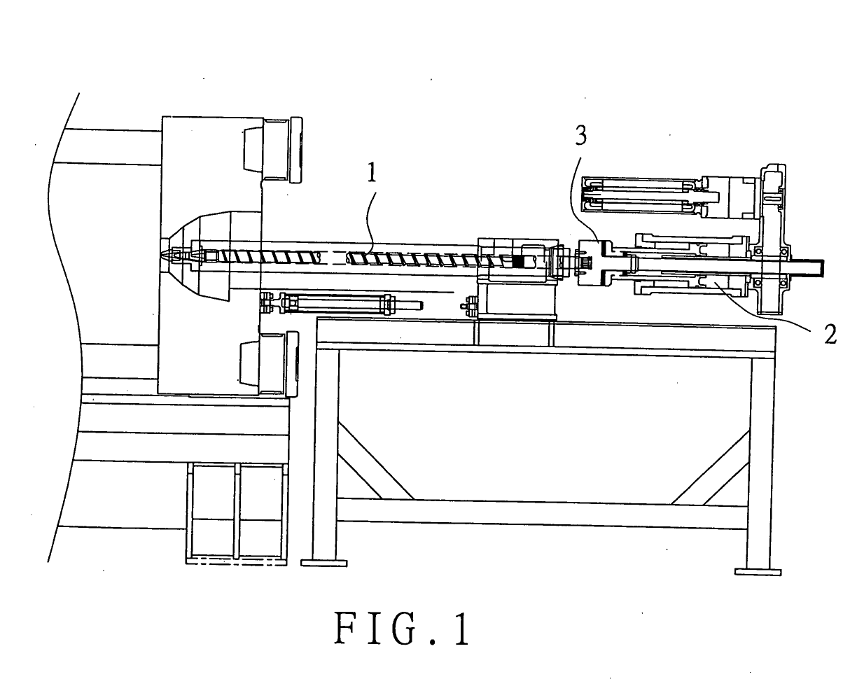

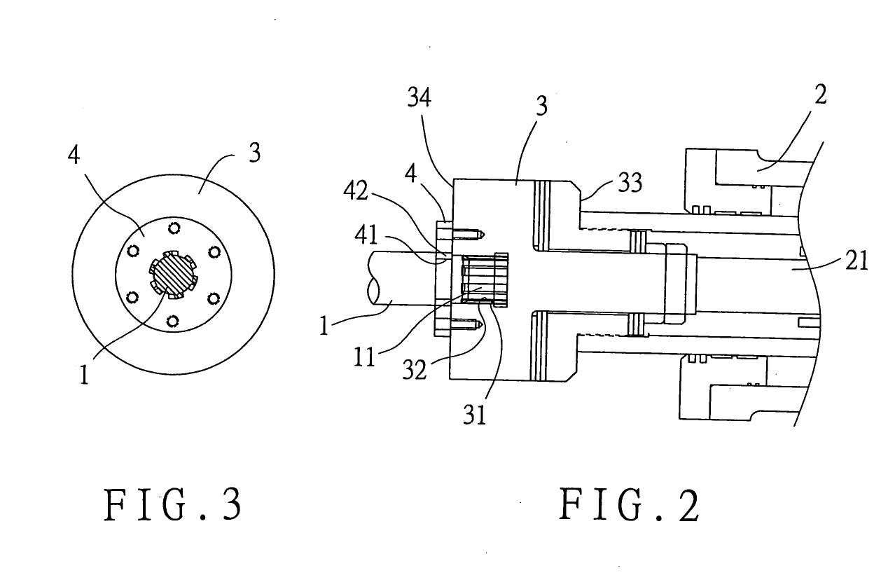

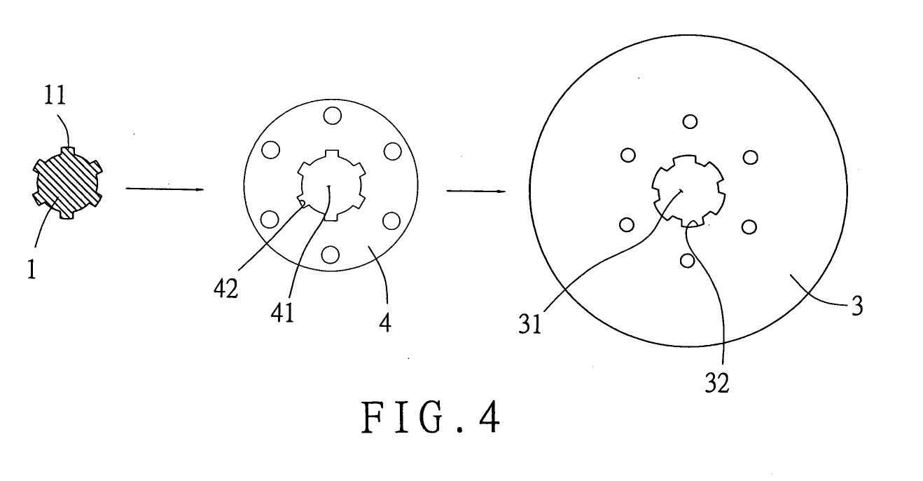

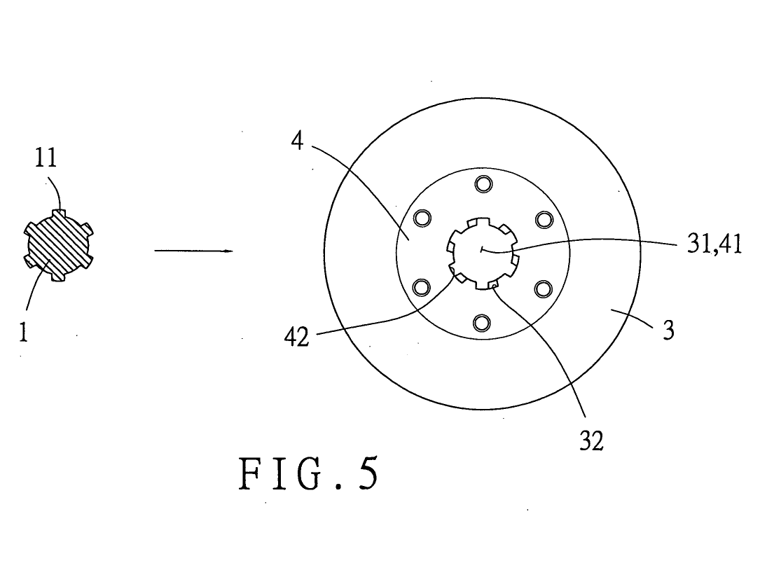

Sown in FIGS. 1 and 2 is a first preferred embodiment of a fast-to-install structure for a threaded rod of an injection molding machine, which includes:

a threaded rod 1 for injecting plastic materials into a mold; the threaded rod 1 has several wedging protrusions 11 on one end thereof; the wedging protrusions 11 can be formed together with the threaded rod 1 as an inseparable part;

an oil hydraulic motor 2 having a working shaft 21 for causing the threaded rod 1 to rotate;

a shaft coupling 3 interposed between the working shaft 21 of the oil hydraulic motor 2 and the threaded rod 1; the shaft coupling has first and second ends 33 and 34; the shaft coupling 3 is connected to the working shaft 21 of the oil hydraulic motor 2 at the first end 33 thereof; the shaft coupling 3 has an axial connecting hole 31 at the second end 34, and several hollow detainment portions 32 inside, which are adjacent to the axial connecting hole 31; the hollow detainment portions 32 have a greater width than the wedging protrusions 11 of the threaded rod 1; and

a stopping slab member 4 secured on the second end 34 of the shaft coupling 3; the stopping slab member 4 has a receiving hole 41, and several grooves 42 on an inner side thereof, which are adjacent to the receiving hole 41; the grooves 42 of the stopping slab member 4 are each faced with only a portion of a corresponding said shaft coupling hollow detainment portion 32; in other words, an opening of each of the hollow detainment portions 32 of the shaft coupling 3 is partly covered and blocked by means of the stopping slab member 4.

The threaded rod 1 is passed through the receiving hole 41 of the stopping slab member 4, and joined to the shaft coupling 3 with the wedging protrusions 11 being passed through respective said grooves 42 of the stopping slab member 4 as well as being confined in respective said shaft coupling hollow detainment portions 32.

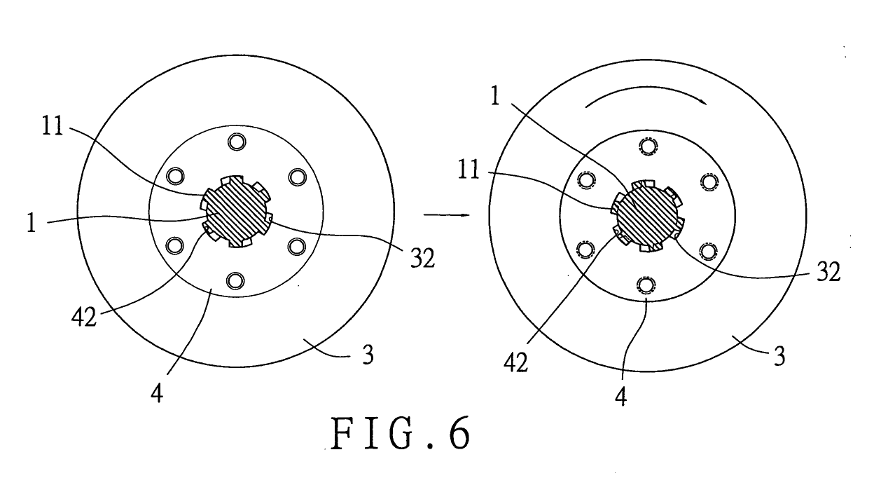

Therefore, the hollow detainment portions 32 of the shaft coupling 3 each will come into contact with a corresponding said threaded rod wedging protrusion 11 at a first end thereof after the oil hydraulic motor 2 has been actuated so as to rotate the shaft coupling 3 in a first direction; at the same time, the stopping slab member 4 will also be angularly displaced relative to the threaded rod 1 such that the grooves 42 thereof no longer face corresponding said wedging protrusions 11, as shown in the right drawing of FIG. 6, and the threaded rod 1 is prevented from being moved in an axial direction to separate from the shaft coupling 3 owing to the stopping slab member 4 and the wedging protrusions 11. Consequently, the threaded rod 1 can be rotated together with the shaft coupling 3 in the first direction by means of the oil hydraulic motor 2.

Furthermore, after the oil hydraulic motor 2 has been actuated so as to rotate the shaft coupling 3 in a second (reverse) direction, the hollow detainment portions 32 of the shaft coupling 3 each will come into contact with a corresponding said threaded rod wedging protrusion 11 at a second end thereof; at the same time, the stopping slab member 4 will also be angularly displaced relative to the threaded rod 1 such that the grooves 42 become faced with corresponding said wedging protrusions 11, as shown in the left drawing of FIG. 6. Consequently, the threaded rod 1 is no longer stopped from moving in an axial direction relative to the shaft coupling 3 by the stopping slab member 4, and is free to separate from the shaft coupling 3.

Therefore, the fast-to-install structure allows the threaded rod 1 to be installed on and separated from the injection molding machine in a relatively short time.

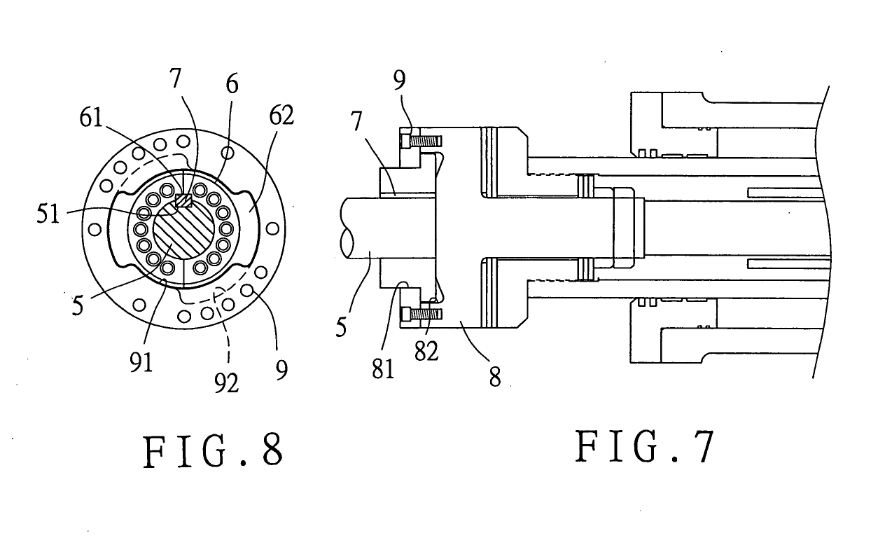

Sown in FIGS. 7 and 8 is another preferred embodiment of a fast-to-install structure for a threaded rod of an injection molding machine, which includes:

a threaded rod 5; the threaded rod 5 has a keyway 51 on a first end thereof;

an oil hydraulic motor (not shown) having a working shaft for causing the threaded rod 5 to rotate;

a shaft coupling 8 interposed between the working shaft of the oil hydraulic motor and the threaded rod 5; the shaft coupling 8 is connected to the working shaft of the oil hydraulic motor at a first end; the shaft coupling 8 has an axial connecting hole 81 at a second end, and two hollow detainment portions 82 inside, which are adjacent to the axial connecting hole 81; and

a stopping slab member 9 secured on the second end of the shaft coupling 8; the stopping slab member 91 has a receiving hole 91, and two grooves 92 on an inner side thereof, which are adjacent to the receiving hole 91; the grooves 92 are each faced with only a portion of a corresponding said shaft coupling hollow detainment portion 82; in other words, each of the hollow detainment portions 82 of the shaft coupling 8 is partly covered with the stopping slab member 9; and

a shaft sleeve 6 positioned around and securely joined to the first end of the threaded rod 5; the shaft sleeve 6 has a keyway 61 facing the keyway 51 of the threaded rod 5, and a key 61 is tightly inserted in both the keyways 51 and 61; the shaft sleeve 6 has two wedging protrusions 62 thereon; the shaft sleeve 6 is joined to the shaft coupling 8 with the wedging protrusions 62 being each passed through a corresponding said groove 92 of the stopping slab member 9 as well as being confined in a corresponding said hollow detainment portion 82 of the shaft coupling 8; the wedging protrusions 62 of the shaft sleeve 6 have a smaller width than the hollow detainment portions 82 of the shaft coupling 8.

Therefore, the hollow detainment portions 82 of the shaft coupling 8 each will come into contact with a corresponding said wedging protrusion 62 at a first end thereof after the oil hydraulic motor has been actuated so as to rotate the shaft coupling 3 in a first direction; at the same time, the stopping slab member 9 will also be angularly displaced relative to the shaft sleeve 6 such that the grooves 92 thereof no longer face corresponding said wedging protrusions 62, and the shaft sleeve 6 is stopped from moving in an axial direction by means of the stopping slab member 9; thus, both the threaded rod 5 and the shaft sleeve 6 are prevented from being moved in an axial direction to separate from the shaft coupling 8. Consequently, the threaded rod 5 can be rotated together with the shaft coupling 8 in the first direction by means of the oil hydraulic motor.

Furthermore, after the oil hydraulic motor has been actuated so as to rotate the shaft coupling 8 in a second (reverse) direction, the hollow detainment portions 82 each will come into contact with a corresponding said shaft sleeve wedging protrusion 62 at a second end thereof; at the same time, the stopping slab member 9 will also be angularly displaced relative to the shaft sleeve 6 such that the grooves 92 become faced with corresponding said wedging protrusions 62. Consequently, both the shaft sleeve 6 and the threaded rod 5 are no longer stopped from moving in an axial direction to separate from the shaft coupling 8. The key 7 is knocked out of the keyways 51 and 61 to allow the threaded rod 5 and the shaft sleeve 6 to separate for replacement, repair and maintenance of the threaded rod 5 after the shaft sleeve 6 and the threaded rod 5 together have been separated from the shaft coupling 8.

From the above description, it can be seen that the present invention has the following advantages:

1. The present invention has a simple structure, and allows the threaded rod to be installed on and separated from the injection molding machine in a relatively short time.

2. The present invention mainly includes a stopping slab member blocking a portion of an opening of each of the hollow detainment portions of the shaft coupling, whose hollow detainment portions each receives a corresponding threaded rod wedging protrusion; after the shaft coupling has been rotated in a forward direction in order for the grooves of the stopping slab member to be away from corresponding wedging protrusions, the threaded rod is prevented from moving in an axial direction to separate from the shaft coupling. Therefore, the threaded rod is easy to install.

3. The present invention allows the threaded rod to be easily and rapidly dismounted for replacement; after the shaft coupling has been rotated in a reverse direction in order for the grooves of the stopping slab member to face the corresponding wedging protrusions, the threaded rod is free to move in an axial direction to separate from the shaft coupling.

4. The threaded rod and the shaft coupling are formed with wedging protrusions and hollow detainment portions respectively, which can work together with only the stopping slab member to achieve the goal of the present invention. Therefore, the present invention is uncomplicated, economical and convenient to use.

What is claimed is:

1. A fast-to-install structure for a threaded rod of an injection molding machine, comprising
a shaft coupling interposed between a working shaft of an oil hydraulic motor and a threaded rod; said shaft coupling having first and second ends;
a stopping slab member secured on said second end of said shaft coupling;
said shaft coupling being connected to said working shaft of said oil hydraulic motor at said first end thereof;
said shaft coupling having an axial connecting hole at said second end; said shaft coupling having a hollow detainment portion adjacent to said axial connecting hole therein;
said stopping slab member having a receiving hole; said stopping slab member having a groove adjacent to said receiving hole therein; said groove of said stopping slab member being faced with only a portion of said hollow detainment portion of said shaft coupling;
said threaded rod having a wedging protrusion piece on one end thereof; said threaded rod being joined to said shaft coupling with said wedging protrusion piece being passed through said groove of said stopping slab member as well as being confined in said hollow detainment portion of said shaft coupling; said hollow detainment portion of said shaft coupling being going to come into contact with said wedging protrusion piece of said threaded rod at one of two ends thereof after said shaft coupling has been rotated by means of said oil hydraulic motor.

2. A fast-to-install structure for a threaded rod of an injection molding machine, comprising
a shaft coupling interposed between a working shaft of an oil hydraulic motor and a threaded rod; said shaft coupling having first and second ends;
a stopping slab member secured on said second end of said shaft coupling;
said shaft coupling being connected to said working shaft of said oil hydraulic motor at said first end thereof;
said shaft coupling having an axial connecting hole at said second end; said shaft coupling having a plurality of hollow detainment portions adjacent to said axial connecting hole therein;
said stopping slab member having a receiving hole; said stopping slab member having a plurality of grooves adjacent to said receiving hole therein; said grooves of said stopping slab member each being faced with only a portion of a corresponding said hollow detainment portion of said shaft coupling;
said threaded rod having a plurality of wedging protrusions on one end thereof; said wedging protrusions being formed together with said threaded rod as an inseparable part of said threaded rod; said threaded rod being joined to said shaft coupling with said wedging protrusions being passed through respective said grooves of said stopping slab member as well as being confined in respective said hollow detainment portions of said shaft coupling; said hollow detainment portions of said shaft coupling each being going to come into contact with a corresponding said threaded rod wedging protrusion at one of two ends thereof after said shaft coupling has been rotated.

3. A fast-to-install structure for a threaded rod of an injection molding machine, comprising
a shaft coupling interposed between a working shaft of an oil hydraulic motor and a threaded rod; said shaft coupling having first and second ends;
a stopping slab member secured on said second end of said shaft coupling;
a shaft sleeve securely joined to one end of said threaded rod;
said shaft coupling being connected to said working shaft of said oil hydraulic motor at said first end thereof;
said shaft coupling having an axial connecting hole at said second end; said shaft coupling having a hollow detainment portion adjacent to said axial connecting hole therein;
said stopping slab member having a receiving hole; said stopping slab member having a groove adjacent to said receiving hole therein;
said groove of said stopping slab member being faced with only a portion of said hollow detainment portion of said shaft coupling;
said shaft sleeve having a wedging protrusion piece thereon; said shaft sleeve being joined to said shaft coupling with said wedging protrusion piece being passed through said groove of said stopping slab member as well as being confined in said hollow detainment portion of said shaft coupling; said hollow detainment portion of said shaft coupling being going to come into contact with said wedging protrusion piece of the shaft sleeve at one of two ends thereof after said shaft coupling has been rotated.

4. The fast-to-install structure for a threaded rod of an injection molding machine, as recited in claim 3, wherein each of the threaded rod and the shaft sleeve has a keyway thereon; both the keyways facing each other; a key being inserted in both the keyways so as to securely join the threaded rod and the shaft sleeve together.
